(19) United States
(12) Patent Application Publication
(10) Pub. No.: US 2013/0194482 A1
(43) Pub. Date: Aug. 1, 2013

(54) SOLID STATE IMAGE SENSOR AND MANUFACTURING METHOD THEREOF

(71) Applicant: STMicroelectronics (Research & Development) Limited, Marlow (GB)

(72) Inventors: Robert Nicol, Lanark (GB); Christopher Wilkinson, Penicuik (GB); Brent Hearn, East Calder (GB)

(73) Assignee: STMicroelectronics (Research & Development) Limited, Marlow (GB)

(21) Appl. No.: 13/748,982

(22) Filed: Jan. 24, 2013

(30) Foreign Application Priority Data
Feb. 1, 2012 (GB) 1201731.5

(51) Int. Cl. H04N 5/225; G06F 17/50

(52) U.S. Cl. CPC H04N 5/2254; G06F 17/50
USPC 348/340; 703/1

(57) ABSTRACT

An image sensor is formed by a pixel array and a microlens array. One microlens is associated with each pixel. The microlens is positioned in a manner that is offset from a center of its associated pixel. The positioning offset for the microlens is a combination of a first offset determined as a function of the pixel's position relative to a center of the image sensor and a second offset that is randomly selected (both in terms of distance and radial direction). The random offset provides the effect that the spatial frequency information from the shifted microlens array is randomly distributed so as to provide different spatial frequencies and effectively cancel out Moiré interference.

### PRIORITY CLAIM

This application claims priority from Great Britain Application for Patent No. 1201731.5 filed Feb. 1, 2012, the disclosure of which is hereby incorporated by reference.

### TECHNICAL FIELD

The present invention relates to a manufacturing method of solid state image sensors of the type including an array of light sensitive elements (i.e., pixels) as well as an array of microlenses disposed in front of the pixel array, and more particularly, to the method of generating an improved layout for the pixels and each one of their respective microlenses.

### BACKGROUND

A conventional solid state image sensor, such as a CCD (charged coupled device) or a CMOS (complementary metal oxide semiconductor), includes an array of light sensitive pixels. However, not all of the area of each pixel is photosensitive and light impinging on the non-sensitive pixel area is not collected, therefore, resulting in a loss of sensitivity and degraded performance. This is particularly the case in small image sensors with high megapixel counts which are predominantly used in mobile phone cameras or other generally small mobile devices.

Such a loss of sensitivity may be compensated by an array of microlenses which is placed in front of the pixels to collect and focus the light onto the photosensitive area of its respective pixels. Further sensitivity losses (e.g., “vignetting”) caused from light rays that are not perpendicular to the sensor surface may also be compensated by shifting the position of respective microlenses relative to their corresponding pixels in accordance with the distance of respective pixel from a central optical axis of the image sensor. An example of such an image sensor is described in US Published Application 2002/0079491, the disclosure of which is hereby incorporated by reference. In particular, each one of the microlenses is shifted in a mathematical relationship to the chief ray angle (CRA) of the microlens used with the sensor, thus creating a systematically arranged “mismatch” between the pixel array and the microlens array. Another specific example of a method for manufacturing an image sensor having an array of pixels and an imaging lens exit pupil is described in US Published Application 2005/0266603, the disclosure of which is hereby incorporated by reference. This method includes positioning a lens for each pixel relative to its associated light sensitive region based on a range of acceptable angles of incidence for the rays of light from the imaging lens exit pupil.

A simplified example of a possible arrangement is shown in FIG. 1(a) and FIG. 1(b). FIG. 1(a) shows a plan view of a simplified pixel array 1 and the positions of the center axis 3 of each microlens 4 relative to the center axis 5 of its corresponding pixel 7. Each microlens 3 is shifted with respect to the central optical axis 9 of the image sensor 1 by a distance and in a direction (e.g., d1, d2) that is determined in accordance with the position of each microlens 3 relative to the central optical axis 9. FIG. 1(b) shows a side view cross section along A-B, and light having a non-perpendicular CRA deviated towards the photosensitive area 5 of the pixels.

However, the systematically created “mismatch” may cause the image sensor to sample disturbing interference patterns, also known as Moiré patterns. A Moiré pattern is an interference pattern created, for example, when two entities with regular structures (e.g., a grid pattern such as the pixel array and a grid pattern defined by the microlens array) are overlaid at an angle (e.g., rotated relative to each other), or when those regular patterns have slightly different mesh sizes (i.e., different spatial frequencies). FIGS. 2(a) and 2(b) illustrate examples of Moiré patterns from superimposing grid lines 11 and 13.

Superimposing regular structures such as the pixel array and the microlens array and shifting the microlenses relative to the pixel array, thus changing the spatial frequency of the microlens array, may cause an aliasing effect such as the Moiré patterns that is sampled by the image sensor. The efficiency of sampling the Moiré pattern increases, for example, (i) when the pixel array is relatively large (e.g., high megapixel cameras), or (ii) when the rate of change of the microlens' CRA versus the pixel pitch is relatively low, therefore resulting in clear fixed pattern noise that is visual in the end image.

Accordingly, there is a need to provide an improved solid state image sensor having reduced sampling efficiency of aliasing interferences, such as the Moiré effect, and to provide a manufacturing method of such an improved solid state image sensor.

### SUMMARY

According to a first aspect, there is provided a method for manufacturing an image sensor comprising an array of pixels, and a corresponding array of microlenses disposed in front of said array of pixels, the method comprising the steps of:

(a) calculating a first position of each of said microlenses relative to its corresponding pixel according to a distance of said corresponding pixel from an optical axis of said image sensor;

(b) generating a second position of each of said microlenses that is randomly offset from said respective calculated first position; and

(c) placing each of said microlenses at the respective second position.

The offset may be in a random radial direction and is limited to a maximum distance from said calculated first position.

This provides the effect that, by randomly offsetting the actual position of each one of the microlenses from its calculated shift positions (i.e., the position determined with respect to the central optical axis), the spatial frequency information from the shifted microlens pattern of the microlens array is randomly distributed so as to provide different spatial frequencies and effectively cancelling out the Moiré interferences. In particular, during the manufacturing process of the image sensor, a layout of the pixel array and its corresponding “shifted” microlens array is generated on a CAD (computer aided design) system and used in order to generate masks applied to the photoresist layer, so as to transfer the geometric layout and/or positions onto a wafer during the photolithography process. When generating the CAD layout for the microlens array, a random offset from the calculated shift position of each microlens is generated and applied to the microlens array layout. This new microlens array layout still includes the calculated shift of each microlens with respect to the central optical axis of the image sensor, but also incorporates a random offsets from each of those calculated microlens positions without destroying the general pattern of the calculated shift layout. However, these random offsets “disturb” the spatial frequency information enough to effectively minimize or even remove the Moiré interferences from the end picture without compromising the image quality (minimal degradation).

Also, by providing a limited region (i.e., maximum distance from the calculated first position) for the offset around the calculated first microlens position, it is ensured that the random distributions of the microlenses do not derogate the intended effect of the calculated microlens shift, or introduce another spatial frequency that may cause further Moiré patterns.

For example, if the random offset is too small, the Moiré pattern may still be sampled or may even be more accurately sampled. On the other hand, if the random offset is too large with respect to the pixel pitch/size, radial intensity banding may also be introduced into the end image.

Steps (a), (b) and (c) may be performed utilizing a CAD software program at maximum snap grid resolution.

This provides the effect that the layout of the pixel array and microlens positions can be created at maximum precision, therefore, minimizing the error that may be introduced from placement inaccuracies. In particular, current pixel array and radial microlens layout CAD system may be able to provide a maximum snap grid resolution at about 2.5 nm or 5.0 nm grid snap spacing.

The maximum distance may be dependent on said pixel size and/or said maximum snap grid resolution of said CAD software program. For example, at currently available high resolution pixel arrays, the maximum snap grid resolution may just be sufficient enough to accurately generate the layout of the pixel array and respective microlenses. Therefore, the maximum offset (maximum distance) may be limited by the maximum snap grid resolution (i.e., not more than the used snap grid spacing) in order to minimize any other errors that may be introduced from diverting too much from the originally calculated first position for each microlens. On the other hand, smaller resolution pixel arrays that have larger pixel sizes (pitches) may allow a maximum offset (i.e., maximum distance) that is larger than the available minimum snap grid spacing and that is limited in accordance with the actual pixel dimensions (pitch).

The second position may be generated by a software subroutine adapted to process said calculated first position. The software subroutine may utilize a random number generator. The software subroutine may be embedded in said CAD software program.

This provides the effect that available CAD software programs can be retrofitted or upgraded to include the additional function(s) required to implement the present embodiment. In particular, random number generators are readily available with current computer systems and operating systems, and may be utilized by the software subroutine processing the data including the calculated first position so as to determine a second position for each one of the calculated first positions that is offset in a random direction and by a random distance from respective calculated first position. Also, the subroutine may take parameters such as pixel size (pitch) and currently used snap grid spacing (e.g., minimum available snap grid spacing) into account to limit the offset (i.e., distance from originally calculated first position) to a maximum distance from the calculated first position (e.g., not more than the used grid spacing, or not more that 10% of the pixel pitch, etc.).

Also, embedding the software subroutine into the existing CAD software or operating system provides the effect that only source code needs to be added or amended to the existing system. However, the software subroutine may also be provided from an external device that is connected to the computer so as to communicate with the CAD software in order to process the data of the calculated first position and provide data of a second, offset position. The external device may be a data storage medium that is connected to and communicates with the computer via USB standard. However, it is understood by the person skilled in the art that any other external device adapted to store and/or execute the software subroutine and that is physically or wirelessly connected to the computer may be used.

According to a second aspect, there is provided a solid state image sensor comprising an array of pixels and a corresponding array of microlenses disposed in front of said array of pixels, in which the placement of each of said microlenses relative to its corresponding pixel is determined according to the method described in the first aspect.

According to a third aspect, there is provided an imaging system including a solid state image sensor as described in the second aspect.

According to a fourth aspect, there is provided a camera including a solid state image sensor as described in the second aspect.

According to a fifth aspect, there is provided a mobile communication device including a solid state image sensor as described in the second aspect.

According to a sixth aspect, there is provided a computer readable storage medium storing a program of instructions to one or more computer, wherein the instructions are adapted to execute the method as described in the first aspect.

This provides the effect that a CAD system can be programmed or upgraded retrospectively to automatically introduce the random offset, taking into account currently available minimum snap grid spacing of the system and the present pixel pitch of the pixel array. Hence, the offset is simply integrated into the currently available standard design flow when generating photolithographic mask layouts for image sensors.

### BRIEF DESCRIPTION OF THE DRAWINGS

Preferred embodiments will now be described, by way of example only and not in any limitative sense, with reference to the accompanying drawings, in which:

FIG. 1(a) is a simplified schematic plane view of a known image sensor having a pixel array and respective microlens array, wherein each microlens is shifted in accordance to its position from the central optical axis of the image sensor,

FIG. 1(b) is a simplified schematic sectional side view of part of the image sensor of FIG. 1(a) further showing light rays being deviated towards the center of the photosensitive area of the image sensor,

FIGS. 2(a) and 2(b) show two examples of simple Moiré patterns generated from “shifted” grid patterns,

FIG. 3 shows a simplified functional diagram of a typical photolithography process using photo masks,

FIG. 4 shows a simplified schematic plane view of an image sensor layout of an embodiment including a pixel array and respective randomly offset microlenses,

FIG. 5 shows a close view of a layout of one pixel and respective microlens of the image sensor as shown in FIG. 3 at the minimum available snap grid spacing of the CAD system including the calculated shift position and the offset position of the microlens,

FIG. 6 shows a close view of an alternative layout of one pixel and respective microlens of the image sensor as shown in FIG. 3 utilizing a greater snap grid spacing of the CAD system, and further showing the placement error introduced from the greater snap grid with respect to the calculated shift position, and

FIG. 7(a) shows an example of an image sensor of an embodiment and manufactured according to the present invention, and

FIG. 7(b) shows a mobile device comprising a camera having the image sensor as shown in FIG. 7(a).

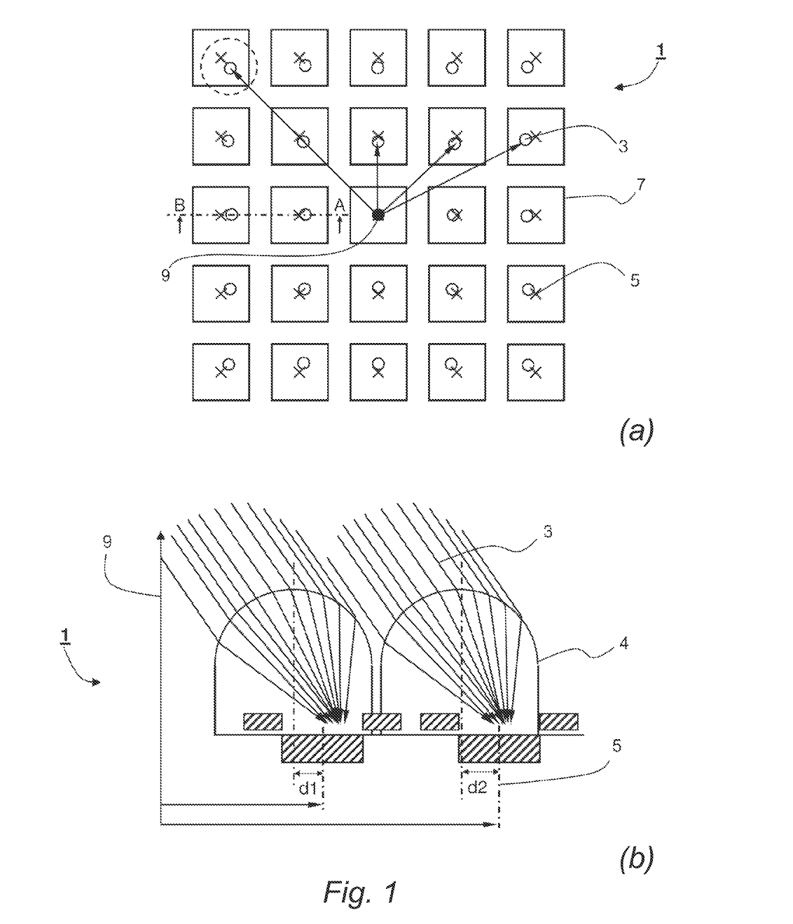

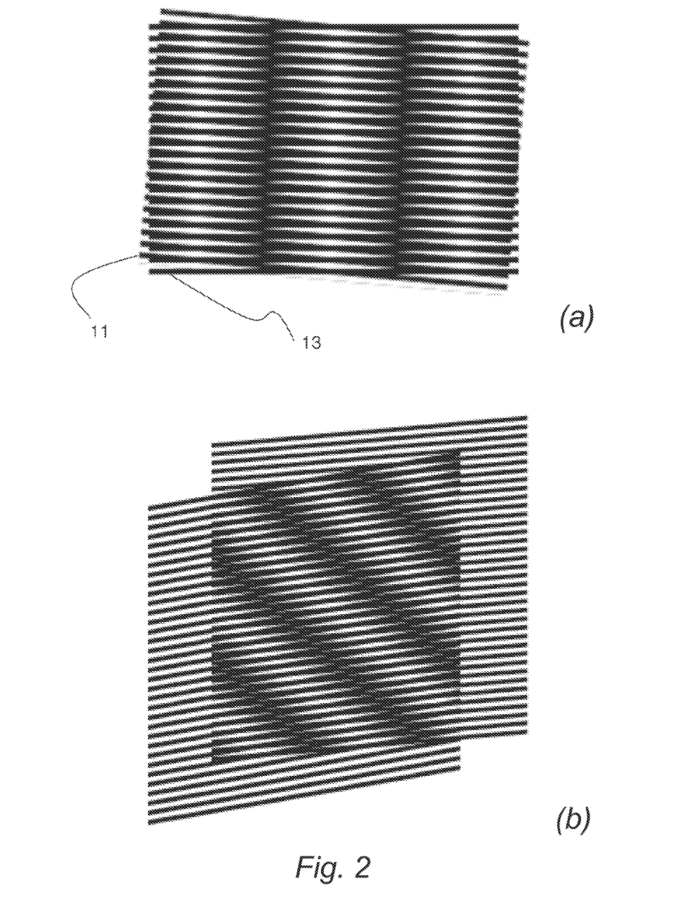

### DETAILED DESCRIPTION OF THE DRAWINGS

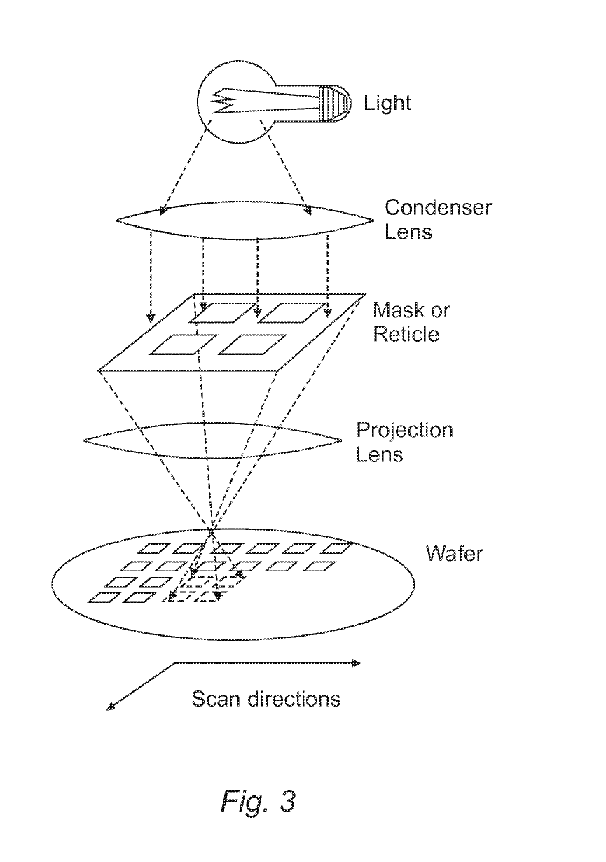

Referring to FIG. 3, when manufacturing CCD or CMOS image sensors a process such as photolithography is used to produce the micropatterns onto the wafer. Before etching out the micropattern, a photoresist layer is exposed to light transferring a geometric pattern from a photo mask. A series of chemical treatments then either engraves the exposure pattern into, or enables deposition of a new material in the desired pattern upon, the material underneath the photo resist. The image for the photo mask originates from a computerized data file usually created on a CAD (Computer Aided Design) system. Therefore, to create the pixel array and respective positions of the microlens array for an image sensor of an embodiment, the layout for the photo mask is preferably created on a CAD system before transferring the respective patterns onto a photo mask, which is then used to manufacture the image sensor of an embodiment.

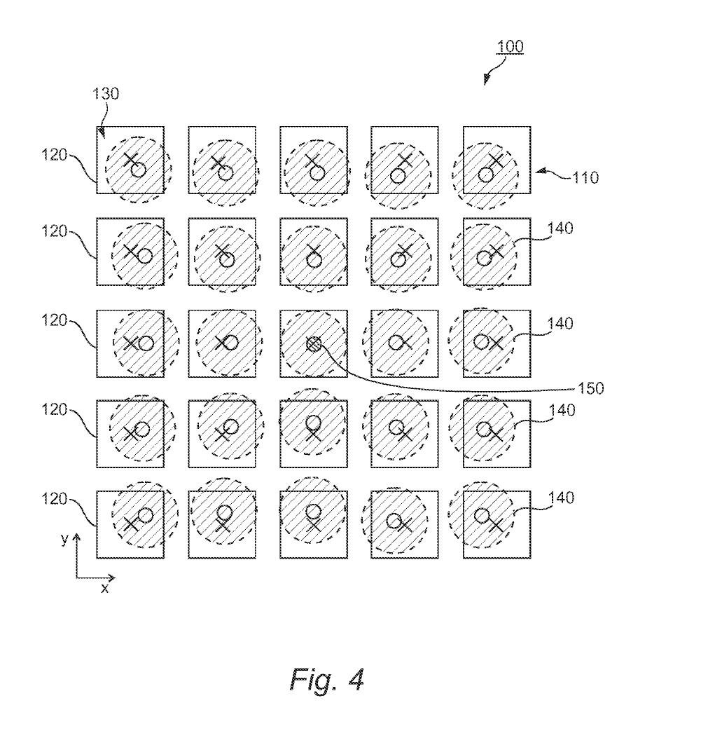

Referring now to FIGS. 4 to 6, a preferred embodiment is disclosed. FIG. 4 shows a simplified “not-to-scale” example of an image sensor 100 comprising a pixel array 110, having a plurality of pixels 120 arranged in a square grid pattern, and a microlens array 130, having a plurality (one for each pixel) of microlenses 140, each shifted from the center of its respective pixel according to the pixels position with respect to the central optical axis 150 of the image sensor, wherein each microlens position is then further randomly offset from the calculated “shift” position. Preferably, the offset is in a random radial direction from the calculated shift position and the maximum distance of the random offset is limited.

In case the image sensor includes a pixel array of maximum available resolution using the maximum available snap grid resolution to create the layout of the photo mask, the offset from the originally calculated shift position is limited to a maximum distance from that originally calculated shift position that is less than the minimum snap grid spacing of the CAD software program. In case the image sensor includes a pixel array of lower resolution, i.e., the pixels size is larger than the practically possible minimum pixel size, than the offset from the originally calculated shift position is limited to a maximum distance from that originally calculated shift position that is dependent on the larger pixel size. The limited (i.e., maximum distance) random offset ensures that the effect of shifting microlenses 140 relative to the pixels 120 of the pixel array 110 in order to reduce “vignetting” is not lost.

Consequently, the random offset around the calculated shift positions of the microlenses changes the spatial frequency of the shifted microlens array 130 so as to reduce the efficiency of the image sensor for sampling Moiré interferences.

In order to generate the random offset, it is understood that any known means may be used. For example, a computer implemented software subroutine utilizing a random number generator may be used to calculate the randomly allocated offset position for each microlens 140. However, it is understood by the person skilled in the art that any other randomization (computer implemented and non-computer implemented) suitable to generate a random position within a predetermined limited region around the calculated shift position may be used.

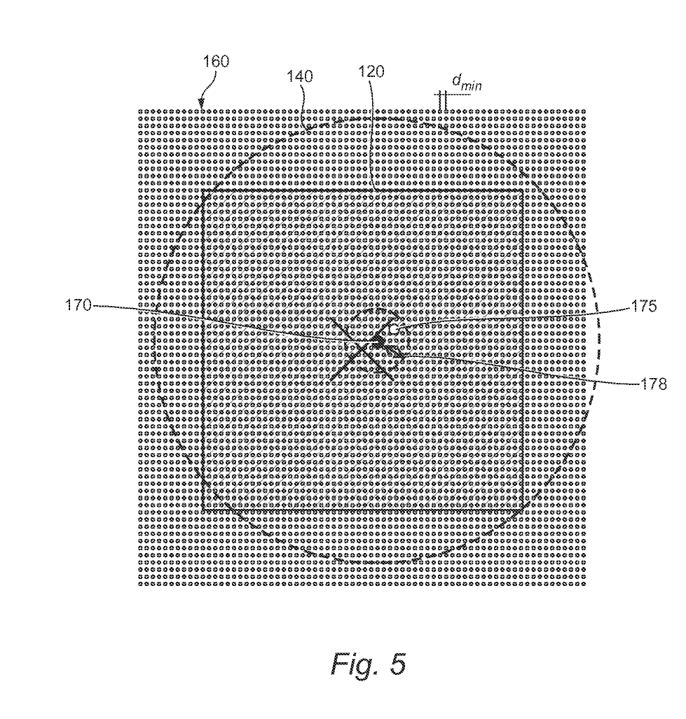

Preferably, however, the random offset may be generated by upgrading a commonly used CAD software program with a software subroutine that is embedded within its source code and that is adapted to process the originally calculated shift position to generate and implement the randomly offset positions to the image sensor layout. FIG. 5 shows a close-up example of a representative pixel 160, the calculated shift position 170 and the computer-generated random offset position 175 of the microlens 140. The dotted circle around the calculated shift position represents the limit 178 of the maximum allowable random offset determined in accordance to the pixel size (e.g., when larger pixels are used to create lower resolution image sensors). In the event a layout for the currently maximum possible pixel array resolution is created (i.e., minimum pixel size) using the minimum available grid spacing dₘᵢₙ, the actual grid spacing will define the limit of the maximum allowable random offset.

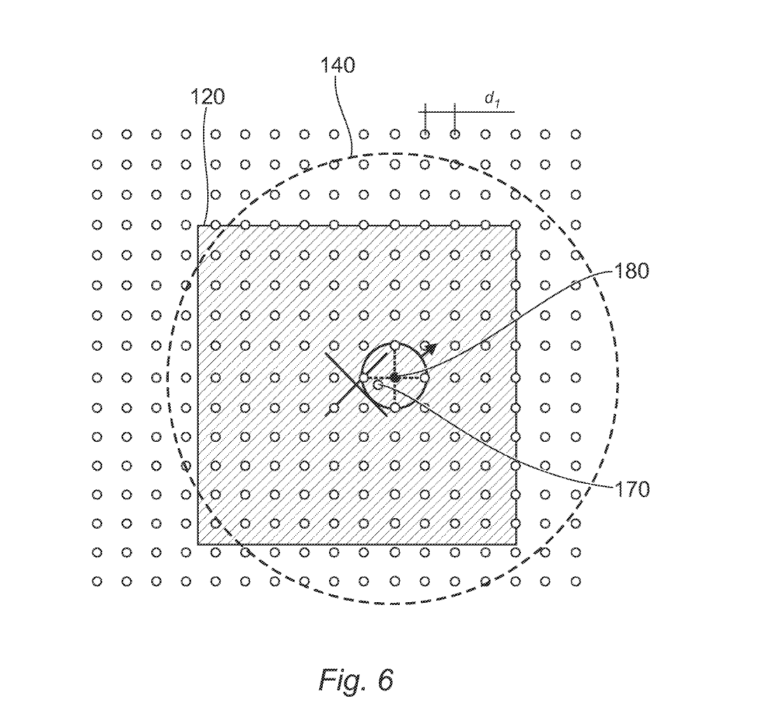

Alternatively, but not preferably, the random offset may be generated utilizing the snap grid 160 of the CAD system used for creating the mask layout. In particular, when creating the layout for the pixel array 110 and the calculated shift positions of respective microlenses 140, the full placement accuracy afforded by the CAD system (i.e., maximum resolution of the snap grid 160) may be used as shown in FIG. 5. Available minimum snap grid spacing dₘᵢₙ may be 2.5 nm or 5 nm providing maximum resolution and placement accuracy. If the same snap grid spacing dₘᵢₙ is used when placing the microlenses at their calculated shift positions, each microlens 140 will be placed at their respective calculated shift position. However, by increasing the snap grid spacing dₘᵢₙ to d₁ and subsequently lower the resolution of the snap grid 160, a placement error is introduced between the calculated shift position 170 of the microlens 140 and the actual placed position (“snapped” to greater snap grid) 180 of the microlens 140 as shown in FIG. 6.

The placement accuracy achieved by the increased snap grid spacing d₁ may be between a minimum of 10% of the minimum available snap grid spacing dₘᵢₙ used when creating the pixel array layout (e.g., 2.5 nm, 5.0 nm) and a maximum of 20% of the pixel pitch used for the pixel array layout. For example, in the case of a 1.4 μm pixel pitch and a minimum snap grid spacing dₘᵢₙ of 5 nm, the boundaries on the microlens placement resolution should be between 280 nm and 0.5 nm, i.e., within a distance of 0.5 nm and 280 nm in any direction radially from the calculated shift position 170.

Therefore, in this alternative example, to generate a random offset for each of the microlenses 140, all that is required is to change the snap grid spacing when placing the microlenses 140 at their respective calculated shift positions 170. The snap grid spacing may be further tuned to match the rate of change of the microlens' CRA versus the pixel pitch.

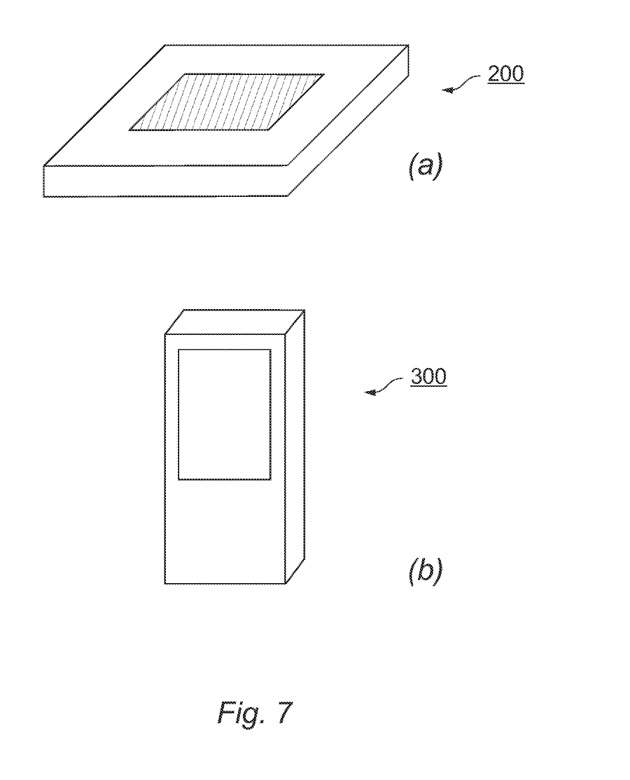

An image sensor 200 incorporating the features of an embodiment is shown in FIG. 7(a). In particular, image sensor 200 has been manufactured using masks layout where the microlenses 140 are placed relative to respective pixels 110 at a snap grid spacing d1 that is larger than the minimum available snap grid spacing dₘᵢₙ used when generating pixel array 110 and calculated shift positions 170, therefore creating a random offset for each one of the microlenses 140. It is understood that the alternative solution is one of many possible ways to create a random offset from the calculated shift position, and may not be the practically preferred method to generate randomly offset layout positions for the microlenses 140.

A mobile device 300 incorporating an image sensor 200 is shown in FIG. 7(b). The mobile device 300 may be a mobile phone comprising and camera.

While this detailed description has set forth some embodiments, the appended claims cover other embodiments which differ from the described embodiments according to various modifications and improvements. For example, the random offset of each microlens 140 from its calculated shift position 170 may be generated by any other suitable means that can be implemented into the CAD system. In addition, the random offset of each microlens 140 from its calculated shift position may be generated during the photolithography process or during the manufacturing step of creating and placing the microlens array 130 onto the pixel array 110.

What is claimed is:

1. A method for manufacturing an image sensor comprising an array of pixels and a corresponding array of microlenses disposed in front of said array of pixels, comprising the steps of:
(a) calculating a first position of each of said microlenses relative to its corresponding pixel according to a distance of said corresponding pixel from an optical axis of said image sensor;
(b) generating a second position of each of said microlenses that is randomly offset from said respective calculated first position;
(c) placing each of said microlenses at the respective second position.

2. The method of claim 1, wherein said offset is in a random radial direction and limited to a maximum distance from said calculated first position.

3. The method of claim 1, wherein steps (a), (b) and (c) are effected utilizing a CAD software program at maximum snap grid resolution.

4. The method of claim 3, wherein said offset is in a random radial direction and limited to a maximum distance from said calculated first position, and wherein said maximum distance is dependent on said pixel's size and/or said maximum snap grid resolution of said CAD software program.

5. The method of claim 1, wherein said second position is generated by a software subroutine adapted to process said calculated first position.

6. The method of claim 5, wherein said software subroutine utilizes a random number generator.

7. The method of claim 5, wherein steps (a), (b) and (c) are effected utilizing a CAD software program at maximum snap grid resolution, and wherein said software subroutine is embedded in said CAD software program.

8. Apparatus, comprising a solid state image sensor including an array of pixels and a corresponding array of microlenses disposed in front of said array of pixels, wherein each of said microlenses is placed relative to its corresponding pixel at a second position randomly offset from a first position, wherein said first position is determined according to a distance of said corresponding pixel from an optical axis of said image sensor.

9. The apparatus of claim 8, wherein the apparatus is an imaging system including the solid state image sensor.

10. The apparatus of claim 8, wherein the apparatus is a camera including the solid state image sensor.

11. The apparatus of claim 8, wherein the apparatus is a mobile communication device including the solid state image sensor.

12. A computer readable storage medium storing a program of instructions to be executed by a computer, wherein the instructions are adapted to perform the steps of:
(a) calculating a first position of each of said microlenses relative to its corresponding pixel according to a distance of said corresponding pixel from an optical axis of said image sensor;
(b) generating a second position of each of said microlenses that is randomly offset from said respective calculated first position;
(c) placing each of said microlenses at the respective second position.

13. The medium of claim 12, wherein said offset is in a random radial direction and limited to a maximum distance from said calculated first position.

14. The medium of claim 13, wherein said offset is in a random radial direction and limited to a maximum distance from said calculated first position, and wherein said maximum distance is dependent on said pixel's size and/or said maximum snap grid resolution.

15. A method, comprising the steps of:
(a) calculating in accordance with a lens positioning algorithm a first position for placement of a microlens at a first distance away from a center of its corresponding pixel sensor according to a positioning algorithm;
(b) generating a second position for placement of said microlens at a second distance away from said first position, where said second distance is randomly selected; and
(c) placing said microlens at said second position instead of said first position.

16. The method of claim 15, wherein the positioning algorithm is based on a mathematical relationship to a chief ray angle (CRA) of the microlens.

17. The method of claim 15, wherein the positioning algorithm is based on a range of acceptable angles of incidence for rays of light from an exit pupil of the microlens.

18. The method of claim 15, further including limiting said second distance.

19. The method of claim 15, wherein the second position offset from said first position in a random radial direction.

20. The method of claim 15, wherein the second distance is limited by a maximum snap grid resolution of a CAD software program.
